(19) United States
(12) Patent Application Publication
(10) Pub. No.: US 2008/0180904 A1
(43) Pub. Date: Jul. 31, 2008

(54) Uniform heat conduction installation

(75) Inventors: Jing-Wen Tzeng, Luchu Hsiang (TW); Shih-Hui Chen, Luchu Hsiang (TW)

Correspondence Address: TROXELL LAW OFFICE PLLC, SUITE 1404, 5205 LEESBURG PIKE, FALLS CHURCH, VA, 22041, US

(73) Assignee: TENNRICH INTERNATIONAL CORP.

(21) Appl. No.: 11/699,068

(22) Filed: Jan. 29, 2007

(51) Int. Cl. G06F 1/20

(52) U.S. Cl. 361/687

(57) ABSTRACT

A uniform heat conduction installation includes a reflection layer and a graphite uniform heat conduction layer with the latter provided on the lower surface of the former; certain portion of thermal energy generated by a heat source disposed on top of the reflection layer is reflected and dissipated by the reflection layer, and the remainder of the thermal energy passes through the reflection layer and is transmitted to the graphite uniform heat conduction layer for the thermal energy to be consistently spread up over the entire surface of the uniform heat conduction installation due to the inherited nature of providing uniform heat conduction effects of the graphite so to achieve better heat dissipation results due to increased area for heat diffusion.

### BACKGROUND OF THE INVENTION

(a) Field of the Invention

The present invention is related to a uniform heat conduction installation, and more particularly, to one that is capable of fast heat conduction and dissipation.

(b) Description of the Prior Art

Whereas certain electronic device, e.g., CPU in a computer, or Northbridge chip creates massive thermal energy in the course of transmission or processing electric signals due to consumption of electric energy from resistance, the performance of the electronic device will be affected, its service life compromised, and even winding up out of function due to damage if the thermal energy fails to be fast and effectively dissipated. Therefore if any electronic device contains element that generates massive thermal energy, heat dissipation becomes a major concern in the design to ensure of the operation performance and extend service life of the electronic device. At present, there are many heat dissipation options available depending on the device and the field of application. According to requirements and limitations from objective conditions for the device, proper heat dissipation means is selected to achieve the heat dissipation purpose.

Either for protecting the electronic installation, its user or simply for attractive appearance, an electronic device is usually placed in a casing, e.g., computer, TV set, MP3 . . . etc., and generally in a plastic casing. The common heat dissipation method provided for these types of electronic installation (e.g., computer) is to provide a heat dissipation installation, e.g., fan, heat sink on a heat generating device to first transmit the heat from the heat generating device to the air inside the case; and multiple ventilation pores are disposed on the casing for the heat to escape from the casing to the ambient air by heat convection. To increase the efficiency of heat convection, a fan is further provided for generating forced convection to facilitate driving out the thermal energy in the casing.

Heat sink fins, ventilation pores, and fan are all methods for heat dissipation depending on the individual needs of the installation. Ventilation pores are usually provided as auxiliary to other means for improving heat convection efficiency, e.g., the fan. However, the fan consumes more power and space, and is not necessarily applicable in certain electronic installation (e.g., thumb disk, wireless network car); on the contrary, the heat dissipation efficiency is poor if ventilation pores are provided with the fan.

### SUMMARY OF THE INVENTION

The primary purpose of the present invention is to provide a uniform heat conduction installation that is simple in construction, fast dissipates the heat consistently, and is even forthwith made in a casing for an electronic device to fast conduct to the ambient air the thermal energy generated by the heat source inside the electronic device when operating.

To achieve the purpose, the present invention includes a reflection layer and a graphite uniform heat conduction layer with the latter provided on the lower surface of the former; certain portion of thermal energy generated by a heat source disposed on top of the reflection layer is reflected and dissipated by the reflection layer, and the remainder of the thermal energy passes through the reflection layer and is transmitted to the graphite uniform heat conduction layer for the thermal energy to be consistently spread up over the entire surface of the uniform heat conduction installation due to the inherited nature of providing uniform heat conduction effects of the graphite so to achieve better heat dissipation results due to increased area for heat diffusion.

### BRIEF DESCRIPTION OF THE DRAWINGS

FIG. 1 is a schematic view showing a construction of a uniform heat conduction installation of the present invention.

FIG. 2 is a schematic view showing an operating status of the uniform heat conduction installation of the present invention.

FIG. 3 is a perspective view showing that the present invention is applied in a notebook.

### DETAILED DESCRIPTION OF THE PREFERRED EMBODIMENTS

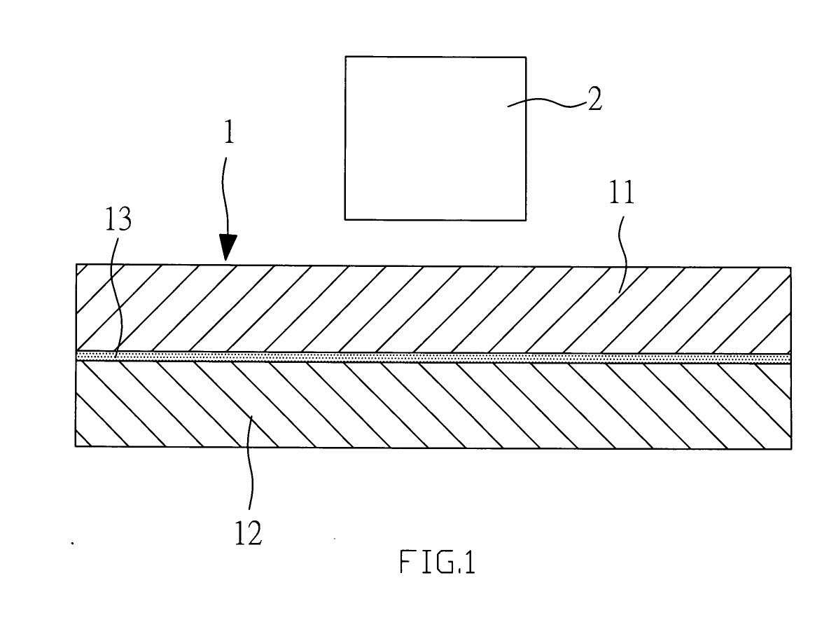

Referring to FIG. 1, a uniform heat conduction installation 1 of the present invention includes a reflection layer 11 related to a metallic layer, e.g., an aluminum layer is provided on its surface one or a plurality of heat source 2 provided over the surface of the reflection layer 11 contacting or not contacting the reflection layer 11, and a graphite uniform heat conduction layer 12 is provided to the lower surface of the reflection layer 11.

The graphite uniform heat conduction layer 12 disposed on the lower surface of the reflection layer 11. As illustrated an adhesive 13 is applied between the reflection layer 11 and the graphite uniform conduction layer 12 for both layers 11, 12 to secure to each other in position; or alternatively, both layers 11, 12 may be secured in position by means of mechanical lamination method. The adhesive 13 may be related to thermal adhesive, thermal melting adhesive, or pressure sensitive adhesive. Wherein, the graphite uniform conduction layer 12 is comprised of an integral piece of graphite or a polymer admixed with graphite powders.

There are four methods for manufacturing the uniform heat conduction installation 1. A first method involves having the reflection layer 11 to be directly adhered to the graphite uniform heat conduction layer 12 or having both layers 11, 12 bonded to each other by mechanical means. A second method is to adhere the reflection layer 11 and the graphite uniform heat conduction layer 12 to both sides of the adhesive 13; or to laminate the reflection layer 11, the adhesive, and the graphite uniform heat conduction layer 12 in sequence by mechanical means. A third method relates to deposit metal using vapor deposition methods including the physical vapor deposition (PVD) method, e.g., evaporation or sputtering; or chemical vapor deposition (CVD) to form the reflection layer 11. A fourth method has first has the adhesive layer 13 bonded to the graphite uniform heat conduction layer 12 either by adhesion or mechanical lamination, and then vapor deposition methods including the physical vapor deposition (PVD) method, e.g., evaporation or sputtering; or chemical vapor deposition (CVD) are used to deposit metal on the surface of the adhesive 13 where not bonded to the graphite uniform heat conduction layer 12 to form the reflection layer 11.

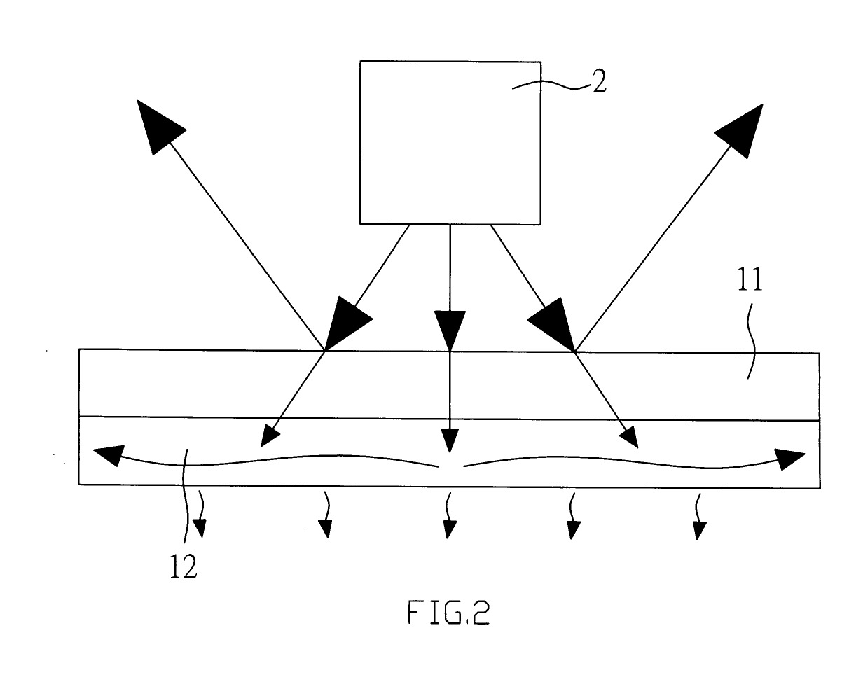

In practice, certain portion of thermal energy emitted from the heat source 2 is reflected and dissipate from the reflection layer 11. As illustrated in FIG. 2, the remainder of thermal energy passes through the reflection layer 11 and is transmitted to the graphite uniform heat conduction layer 12 to be consistently distributed all over the entire graphite uniform heat conduction layer 12 for realizing better heat dissipation effects due to the increased area for diffusing the thermal energy.

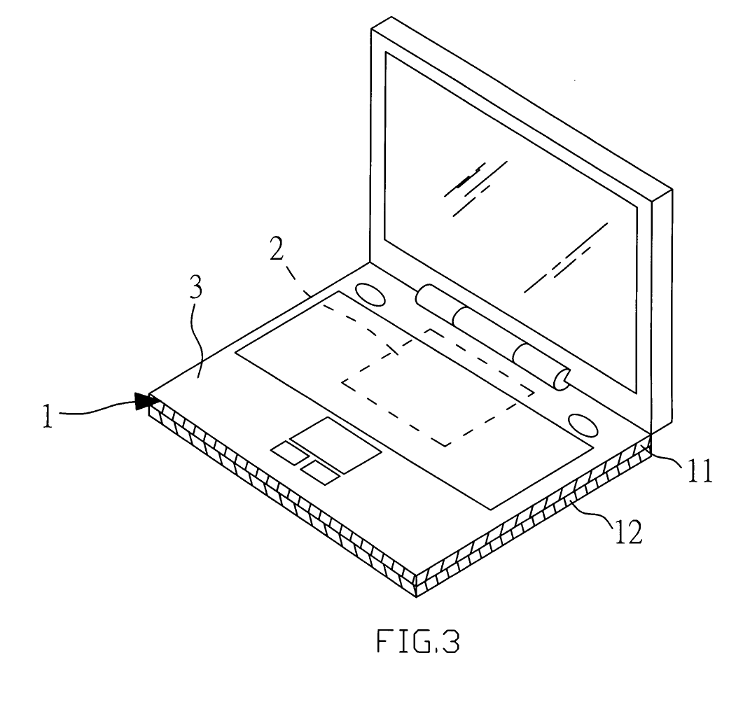

Now referring to FIG. 3 for another preferred embodiment of the present invention, the uniform heat conduction installation 1 is provided in a form of a casing 3 for a notebook computer. As the heat source 2 (i.e., the electronic device) operates, the thermal energy so generated is partially reflected and dissipated from the reflection layer 11 while the remainder of the thermal energy passes through the reflection layer 11 and is transmitted to the graphite uniform heat conduction layer 12 to consistently distribute the thermal energy on the entire surface of the uniform heat conduction installation 1 for achieving better heat dissipation results due to increase are for diffusing thermal energy.

The prevent invention provides an improved structure of a uniform heat conduction installation, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A uniform heat conduction installation includes a reflection layer, one or a plurality of heat source is provided on the reflection layer and a graphic uniform heat conduction layer is disposed on the lower surface of the reflection layer.

2. The uniform heat conduction installation as claimed in claim 1, wherein the reflection layer relates to a metallic layer.

3. The uniform heat conduction installation as claimed in claim 1, wherein the reflection layer relates to an aluminum layer.

4. The uniform heat conduction installation as claimed in claim 1, wherein both of the reflection layer and the graphite uniform heat conduction layer are attached and secured to each other by means of an adhesive.

5. The uniform heat conduction installation as claimed in claim 4, wherein the adhesive relates to a thermal adhesive.

6. The uniform heat conduction installation as claimed in claim 4, wherein the adhesive relates to a thermal melting adhesive.

7. The uniform heat conduction installation as claimed in claim 4, wherein the adhesive relates to a pressure-sensitive adhesive.

8. The uniform heat conduction installation as claimed in claim 1, wherein both of the reflection layer and the graphite uniform heat conduction layer are secured to each other by using a mechanical lamination means.

9. The uniform heat conduction installation as claimed in claim 1, wherein the heat source is provided on the upper surface of the reflection layer.

10. The uniform heat conduction installation as claimed in claim 1, wherein the graphite uniform heat conduction layer is comprised of an entire piece of graphite.

11. The uniform heat conduction installation as claimed in claim 1, wherein the graphite uniform heat conduction layer is comprised of a polymer admixed with graphic powders.

12. The uniform heat conduction installation as claimed in claim 2, wherein the metallic layer is formed using a physical vapor deposition method.

13. The uniform heat conduction installation as claimed in claim 2, wherein the metallic layer is formed using a chemical vapor deposition method.

14. The uniform heat conduction installation as claimed in claim 12, wherein the physical vapor deposition method relates to evaporation.

15. The uniform heat conduction installation as claimed in claim 12, wherein the physical vapor deposition method relates to spurting.

16. A method for manufacturing a uniform heat conduction installation involves having a metallic layer is provided using a vapor deposition method on a surface of a graphic uniform heat conduction layer; and the metallic layer is related to a reflection layer.

17. A method for manufacturing a uniform heat conduction installation involves having first applied a course of adhesive on a surface of a graphite uniform heat conduction layer, and a metallic layer is provided using a vapor deposition method on a surface of the adhesive not contacting the graphite uniform heat conduction layer; and the metallic layer is related to a reflection layer.

18. The method for manufacturing the uniform heat conduction installation as claimed in claim 16, wherein the vapor deposition method relates to a physical vapor deposition method.

19. The method for manufacturing the uniform heat conduction installation as claimed in claim 17, wherein the vapor deposition method relates to a physical vapor deposition method.
